(19) United States
(12) Patent Application Publication
(10) Pub. No.: US 2007/0126598 A1
(43) Pub. Date: Jun. 7, 2007

(54) Portable boom gate apparatus

(76) Inventors: Brent Carter, Queensland (AU); Terence Justin Wolff, Toowoomba (AU)

Correspondence Address: HOFFMANN & BARON, LLP, 6900 JERICHO TURNPIKE, SYOSSET, NY, 11791, US

(21) Appl. No.: 10/582,806

(22) PCT Filed: Nov. 18, 2004
(86) PCT No.: PCT/AU04/01600

§ 371 Date: Feb. 8, 2007

(30) Foreign Application Priority Data
Nov. 18, 2003 (AU) 2003906350

(51) Int. Cl. G08G 1/095

(52) U.S. Cl. 340/908; 49/13; 404/6; 4/232

(57) ABSTRACT

Boom gate apparatus (10) including: (i) a portable trolley (13); (ii) an elongate gate (11) mounted to the portable body (13); and (iii) actuating means (41) for moving the elongate gate from an upright non-operational position to a horizontal operational position characterised in that; (iv) said actuating means is controlled by a hand held controller or transmitter (50).

This invention relates to portable boom gate apparatus which may be employed at road crossings or any other location where it is necessary for pedestrians to cross a carriageway or road adapted to be travelled by cars, trucks, trains or trams or other form of vehicular traffic.

A conventional portable boom gate apparatus is described in U.S. Pat. No. 6,886,519 which describes a portable boom gate and an oversize representation of a flagman wherein both the portable boom gate and the flagman are pivotally mounted to a vehicle trailer and adapted to be moved from an upright operational position blocking a portion of a roadway to a non-operational position unblocking the roadway. The boom gate has stop lights only observable by approaching motorists when the flagman and boom is in the upright operational position. The trailer includes a power source such as a battery pack mounted on the trailer which provides power to an electric motor.

There is also provided a winch carried by a drive shaft of the electric motor. There is also provided a cable wound around the winch. When the cable is unwound this facilitates movement of the boom gate from the non-operational position to the operational position. This is accomplished by a remotely controlled switch and a control linkage operably connecting the switch, power pack and the winch. The power pack also provides power to the stop lights.

However the above described boom gate apparatus was not only cumbersome in structure requiring a supporting trailer but the method of actuation of the boom gate using the winch was unduly complicated. This conclusion was also relevant to the use of the replica of the flagman.

U.S. Pat. Nos. 4,844,653 and 5,097,790 also refer to boom gate apparatus having a base structure which pivotally supports an elongate arm from movement from a lowered position where the elongate arm extends horizontally blocking a lane of a roadway to a raised position where the arm extends above the roadway. U.S. Pat. No. 5,097,790 is specifically directed to the use of signs at each end of the elongate arm which are rotationally mounted to the boom gate apparatus. One sign directs traffic to proceed through the boom gate apparatus when the arm is in the raised position and the other sign directs traffic to stop when the arm blocks the roadway.

U.S. Pat. No. 4,844,653 is specifically directed to a semaphore type boom gate apparatus which requires spaced posts at opposite sides of the roadway. One post is a pivot post disposed on a vertical axis with a yieldable mounting rotatable plate on the post to carry a beam to swing between an upright non-operational position and a closed operational horizontal position. There is also provided a cable anchored to the pivot post and carried by the beam with an end engaged on the other post which is fixed in the ground. It is also noted that because of this feature the boom gate apparatus was not portable in nature.

Both U.S. Pat. Nos. 4,844,653 and 5,097,790 are directed to specific structure as described above which were necessary in regard to development of their respective inventive concepts. However such specific structure was not necessary in regard to effective operation of boom gate apparatus.

It also will be appreciated from the prior art described above that such conventional boom gate apparatus could not be used at school crossings because they were not specifically designed for this particular application. This has specific reference to raising and lowering a boom gate by use of a hand held transmitter and/or providing a portable apparatus of simple structure that could be used to block off one or both lanes of a roadway on which traffic could proceed in different directions.

It is therefore an object of the present invention to provide a boom gate apparatus which may achieve either of these objectives and more preferably each of these objectives.

The boom gate apparatus of the invention in a first aspect comprises:
(i) a portable trolley;
(ii) an elongate gate pivotally mounted to the portable trolley; and
(iii) actuating means for moving the elongate gate from an upright non-operational position to a horizontal operational position characterised in that
(iv) said actuating means is controlled by a hand held transmitter or controller.

In a second aspect of the invention there is provided a method of operation of boom gate apparatus having features (i), (ii) and (iii) above wherein a pair of said boom gate apparatus is used to block adjacent lanes of a roadway to thereby prevent passage of traffic in different directions.

In relation to boom gate apparatus of the invention the portable trolley is suitably compact and in one form may comprise a single pair of wheels at a base or bottom end thereof and a handle so that the trolley may be propelled in a similar manner to a hand held hand truck or wheelbarrow. However a portable trolley in the nature of a cart may be used although this is a less desirable feature.

The elongate gate may comprise an elongate arm or even a movable frame if required. However the former arrangement is preferred for the sake of simplicity and convenience.

The actuating means may be of any suitable form and thus may comprise use of a hydraulic or pneumatic ram assembly. However more preferably use is made of a drive motor which is coupled to a chain or drive belt which interconnects a pulley or sprocket on the drive shaft of the motor and another pulley or sprocket which is attached to a pivot arm which is releasably coupled to the elongate gate. In this embodiment the elongate gate may be oriented normal to the pivot arm. Suitably there may be provided a connection sleeve or joint between the elongate gate and the pivot arm wherein the elongate gate is attached to the connection sleeve by a splined or keyway arrangement.

The drive motor is preferably an electric motor powered by one or more batteries.

The mobile trolley suitably comprises a housing for the actuating means. There may also be located in the housing a receiver which receives a signal from the hand-held controller or transmitter. This signal may be infra-red (IR) or radio-frequency (RF). Preferably the hand-held controller is IR and the receiver is IR and thus the housing may have a transparent window located in an external wall thereof. More preferably there is provided an IR receiver in the housing which transmits a signal to an RF receiver in the housing which then sends a signal to a microprocessor which actuates the drive motor discussed above. This arrangement is preferred because it means each of the boom gate apparatus of the invention does not have to be in precise alignment when controlling two way traffic. Suitably the housing may also accommodate the drive motor and one or more batteries for providing

Reference may now be made to a preferred embodiment of the invention as shown in the preferred embodiment wherein:

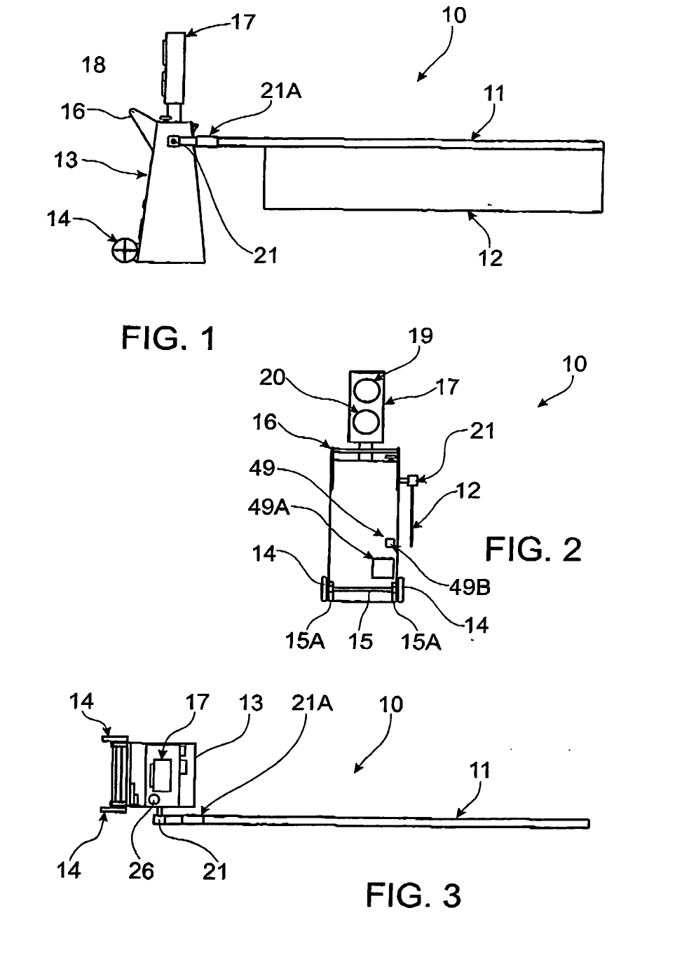

FIG. 1 is a front view of the boom gate apparatus of the invention;

FIG. 2 is a side view of the boom gate apparatus shown in FIG. 1;

FIG. 3 is a plan view of the boom gate apparatus shown in FIG. 1;

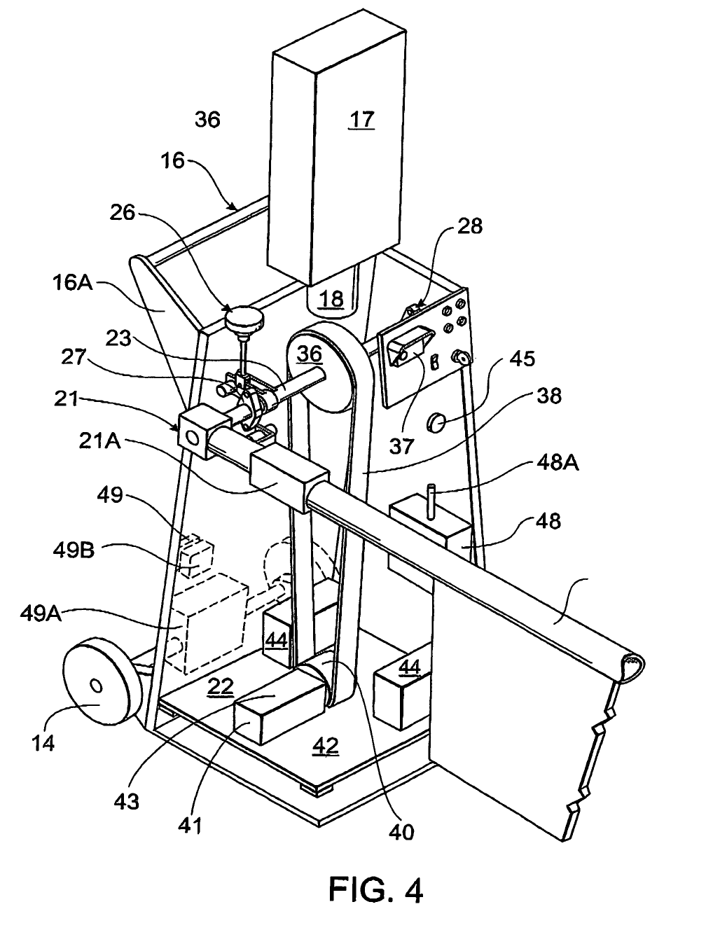

FIG. 4 is an isometric view showing the internal componentry of the support housing;

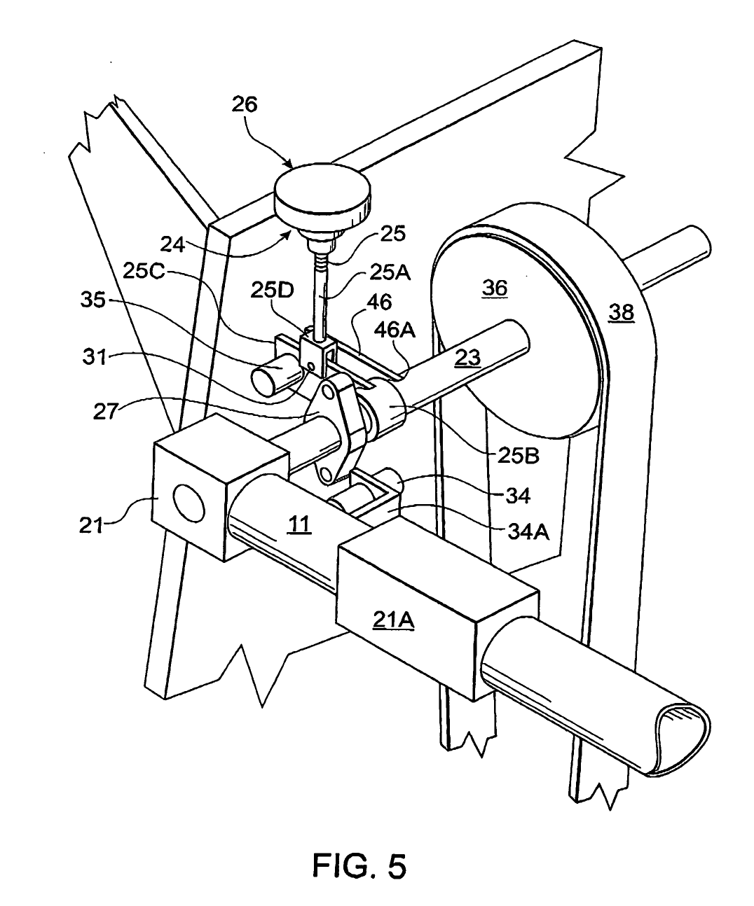

FIG. 5 is an isometric detailed view of the road profile adjustment mechanism.

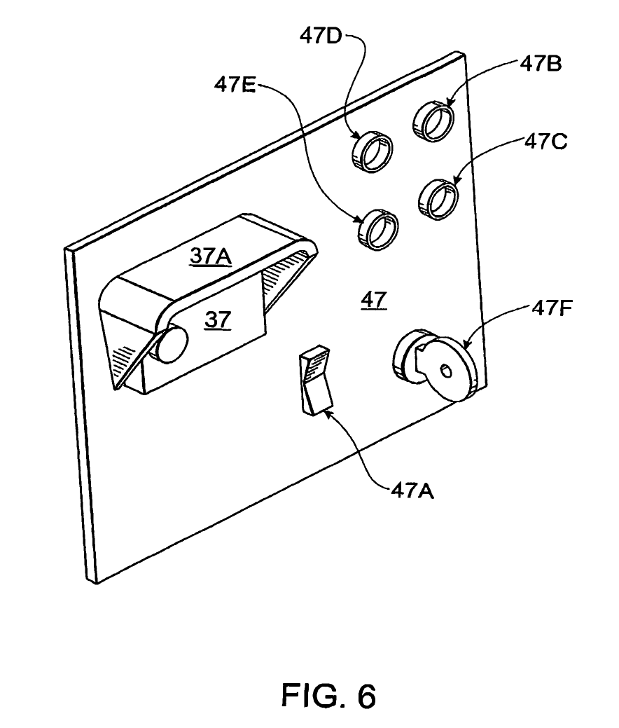

FIG. 6 is a view of the IR receiver panel and manual switches.

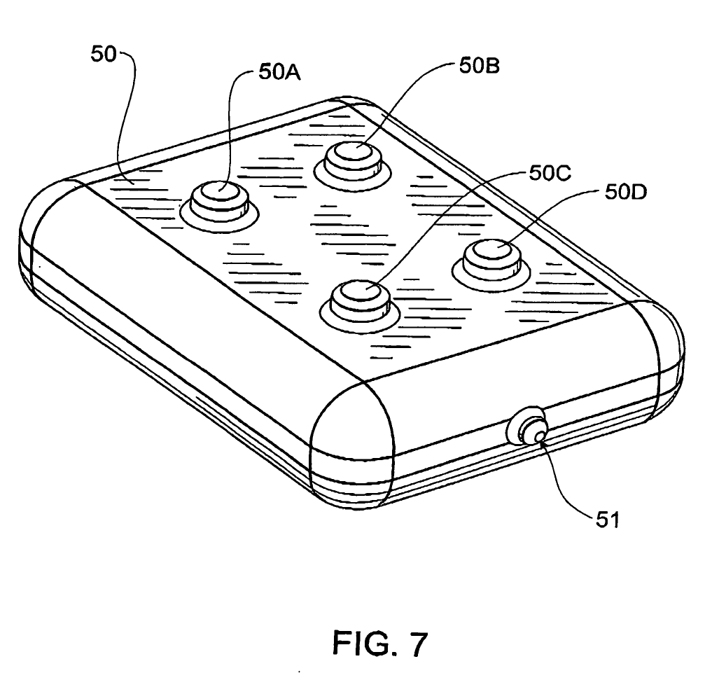

FIG. 7 is an isometric view of the IR hand held controller.

In the boom gate apparatus 10 shown in FIGS. 1-3, there is provided boom 11 having a sign 12 attached thereto made of fluoro type material with the words “STOP CHILDREN'S CROSSING” depicted on sign 12. There is also provided a mobile trolley 13 for boom 11 mounted on ground engaging wheels 14 attached to axle 15 and associated bearings 15A. There is also provided handle 16 mounted to opposed brackets 16A and an indicator 17 mounted to the top of trolley body 13 by post 18. Indicator 17 has lights 19 and 20 indicating WALK or DON'T WALK as the case may be. The boom 11 is releasably attached to attachment sleeve 21 by keyway, spline, plug-socket interaction or other form of releasable attachment means so that attachment sleeve 21 and boom 11 rotate in unison. As shown in FIG. 1 the boom 11 may pivot about 90° from a horizontal operational position to a non-operational upright position. There is also shown a boom snap release mechanism 21A.

As best shown in FIGS. 4-5 mobile trolley 13 has a hollow chassis or housing 22. There is also shown pivot arm 23 for boom 11 as well as an adjustment mechanism 24 for a first proximity switch 35 which adjustment mechanism 24 includes thread 25 and handle or adjustment knob 26. Thread 25 is coextensive with rod 25A. There is also shown bearing assemblies 27 and 28 for support shaft 23. There is also provided a second proximity switch 34 which is used for the up or non-operational vertical position of boom 11. Second proximity switch 34 is mounted to bracket 34A. Proximity switch 35 is used for the down or operational position of boom 11. Proximity switch 35 is attached to a support arm 25C which is attached to bush 25B movable on pivot shaft 23. There is also provided a bracket 25D which supports rod 25A. A fastener (not shown) extends through attachment aperture 31. Pivot shaft 23 has connected to it pulley or sprocket 36. There is also provided a sprocket or lugged timing belt 38 which engages with pulley 36. Belt 38 also engages with a drive pulley or sprocket 40 which is driven by a 12 or 24 volt geared motor 41. Motor 41 is mounted to support plate 42 and drive pulley 40 is attached to drive shaft (not shown) at the end of motor 41. There also may be provided a reduction box (or gear box) (not shown) through which the drive shaft may extend. There is also provided a pair of batteries 44 for powering motor 41. There is also provided a buzzer 45 and a sensor arm 46 attached or welded to pivot shaft 23 at 46A for initiating movement of pivot shaft 23 from the up or down position as is required. There is also shown IR receiver control panel 37 shown in more detail in FIG. 6. There is also provided low battery indicator light 49B, a radio transmitter/receiver 48, antenna 48A, battery charger 49 and control box or microprocessor 49A.

An internal frame (not shown) is located within housing 22 which supports bearing assemblies 27 and 28 and support bracket 34A for limit switch 34 and support arm 25C for limit switch 34. Alternatively, bearing assemblies 27 and 28 and limit switches 34 and 35 may be supported by walls 22A and 22B of housing 22.

In FIG. 6 there is shown an IR receiver control panel 37 having indicator light 37A, stand alone or dual mode switch 47A, manual control switches 47B, 47C, 47D and 47E and off/on manual/automatic key switch 47F.

In FIG. 7 there is shown a battery operated IR controller 50 having control switches 50A, 50B, 50C and 50D and signal sender 51.

In operation of the boom gate apparatus 10 of the invention, it will be appreciated that the portable boom gate apparatus of the invention is designed to clearly indicate to motorists where children or pedestrians are crossing. It will also increase the safety of supervisors of school pedestrian crossings by the fact that the boom 11 is lowered, stopping traffic before the supervisor steps out to the centre of a busy road.

It is not the intention of the apparatus of the invention to actually stop the movement of a motor car driving through a pedestrian crossing but to make a driver aware of the crossing. This is achieved by the lowering of the boom 11, extending from the curb to the centre of the road.

The apparatus of the invention in its most preferred form consists of two portable pedestrian crossing boom gates 10, which are remotely operated and controlled by a human attendant. The operation of the apparatus with regard to the indicator lights 19 and 20 (walk/don't walk) and buzzer 46 are to mimic as closely as possible the action of pedestrian crossing signals at traffic lights etc. so as to clearly indicate to the children that it is safe to cross the road. The apparatus will help educate children to understand this universal crossing indication system.

The boom gate suitably will operate glitch free, with no false triggering and no lost signals because of the safety aspects of working with children in a potentially harmful traffic environment.

The operator of the boom gate signals to the apparatus with the infra-red remote control handset 50 which is similar to that of a television set. The handset is battery powered and provides direct line of sight communication to at least one of the boom gate units situated by a road. To prevent erroneous signalling from other infra-red controls not relevant to the system, the infra-red handset may be security coded. This means that the boom gate may not accept infra-red instructions that do not match its inbuilt security codes.

The reception range of the handset to a boom gate unit would be about 10 to 15 metres depending on atmospheric conditions (dust or fog would limit this range). The operator would stand adjacent or near to a boom gate apparatus 10 and point the handset at the receiver panel 37 on mobile trolley 13 to send operation instructions. The receiver panel 37 would contain a visible light to acknowledge receipt of the IR signal to the operator 37A.

The boom gate apparatus can operate as a single entity or as one of a pair of gates 10. Use of switch 47A would select between stand alone operation and dual operation. In stand alone operation, the apparatus 10 would not transmit to another gate and would not expect a non-existent reply signal.

In dual gate operation, the operation of each boom gate 10 is to cater for a dual lane or split lane crossing situation. The gates work in conjunction on the command of the operator with the use of the IR controller. If the operator signals to either one of the gates 10, dual mode operation allows one boom gate 10 to transfer by way of radio signal the command to the other gate 10. Also, the ability of either of the boom gates 10 to receive activation signals allows the operator to cross over the road and control both gates 10 from alternate sides of the road.

The portable boom gate apparatus 10 may require battery power to operate. This is provided by a couple of 12V/24V sealed lead acid batteries 44, previously described. The batteries 44 are arranged to provide safety critical redundancy for apparatus 10. If one battery fails or becomes fully discharged in the course of operation, then the other acts as a backup. The battery charger 49 must monitor the remaining battery charge and be able to switch batteries automatically. In addition, the battery charger 49 may indicate to the operator that the second battery is engaged as a warning of battery depletion. This battery charger 49 may be recharged from mains power when the batteries 44 are not in operation. Battery charger 49 is of a conventional type.

The actual boom 11 is lowered or raised by the DC motor 41. The motor and its incorporated gear box (not shown) is mounted adjacent to batteries 44 so as to make the unit stable. The proximity switches 34 and 35 control the extent and direction of travel of the boom 11. The motor 41 is controlled by the boom gate logical unit (not shown) located within microprocessor 49A. The adjustment mechanism 24 enables the height of the boom 11 to be controlled so as to suit the road profile.

As stated above, each boom gate apparatus 10 may receive commands from the human operator. The operator activates a handset sending unique coded signals for each different operation of each boom gate apparatus 10. The IR signal is received by one or a number of IR reception panels 37 situated in prominent locations on mobile trolley 10. The IR reception panels may be shaded from direct sunlight to avoid interference from that strong light source. The IR receiver sends the received coded signal to the boom gate logic system 49A for decoding and recognition.

Infra-red systems are fine for short range line of sight communications such as the operator pointing a controller at mobile trolley 10. However current infra-red technology has a limited range, must have line-of-sight and its signal is subject to interference of atmospheric effects such as dust or fog, making it unsuitable for communication between the base units in dual mode operation. To accommodate mobile trolleys 10 that are separated by a relatively large distance (>15 m) such as in a split road system, radio frequency communications may be used.

On receipt of a valid command from the operator, an RF unit working in dual mode would transmit to its pair and wait for receipt of an acknowledgement before physically operating. As with the infra-red signals, the RF signals would be digitally coded to prevent erroneous operation. Furthermore, the signal code would contain redundancy and error correction to identify and correct missing or damaged signals.

These transceiver units may conform to the Low Interference Potential Device Class regulated by the Australian Communication Authority. Either AM or FM modulation would be used at a suggestion carrier frequency of 30 MHz.

Each boom gate apparatus 10 may also have the indication lights 19 and 20 mounted in a prominent position on top of trolley 13 which will mimic the operation of standard pedestrian lights. In addition the buzzer 45 which may be a loud piezo electric buzzer may sound at the same frequencies as standard pedestrian crossing lights to further indicate that it is safe/unsafe to cross the road. These are visual/aural indicators for the children and or pedestrians to indicate it is safe to cross the road, catering for visually and hearing impaired.

The logic or electronic system 49A is responsible for decoding the commands from the IR remote control signals and RF signals between units if in dual operation, activating the boom gate motor 41 and controlling the sequence and timing of the boom 11. It also activates the walk/don't walk lights 19 and 20 and buzzer 45.

The boom 11 may be a three piece telescopic tubular section made from one of the following, plastic, fibreglass, aluminium or a combination of three. It can be extended to approximately 3.5 metres and retracted when require for moving and storing of each boom gate 10. Located near connection sleeve 21 is the snap release system 21A which is designed to allow the boom 11 to disengage from the pivot arm 23 absorbing energy if a vehicle was to hit it. A safety line (not shown) from connection sleeve 21 to boom 11 ensures that the boom 11 does not become airborne and therefore dangerous.

The chassis 22 is fabricated from aluminium and has mountings for the 12 volt electric drive motor, batteries, control box and bearings for the boom pivot shaft. There is also provided handle 16 as well as four extendable mountings 49C shown in FIG. 4 that can be pulled out to stabilise the trolley 13. The trolley 13 may also be provided with screw down feet (not shown) which attach to each mounting 49C to level trolley 13 if necessary.

A single boom gate apparatus 10 or a pair of such boom gate apparatus 10 may be operated having regard to the following sequential steps:
(1) To start the crossing sequence, the operator standing beside one of the booms 10 at the side of the road would determine the traffic is far enough away from the crossing to be safe and would use the remote control 50 by pushing button 50A to lower the boom gates 11.
(2) At this stage the red don't walk light is on. The crossing attendant then walks to the centre of the crossing, checks that conditions are still safe and then pushes button 50C on the remote control which activates the walk buzzer 45 and the green walk lights 20 indicating to the children that it is safe to cross.
(3) At the command of the crossing attendant by pushing button 50D on the remote control, the buzzer sound would change to indicate that no further crossings should commence and the walk indication light 19 would light up red and flash.
(4) When all children have crossed safely or stopped at the side of the road, the operator uses the remote control pushing button 50B a final time to raise the boom gates 11 to allow the flow of traffic to resume. In addition, with this command signal, the don't walk indicator lights (flashing) and buzzers are switched off however the red don't walk light stays on (not flashing) until step 1 is repeated.

It will be appreciated from the foregoing that the portable boom gate apparatus of the invention is extremely suited for use at children's traffic crossings and has substantial advantages over the prior art. It will also be readily apparent that the boom gate apparatus of the invention can be used at any type of pedestrian crossing.

1. Boom gate apparatus comprising:
(i) a portable trolley;
(ii) an elongate gate mounted to the portable body; and
(iii) actuating means for moving the elongate gate from an upright non-operational position to a horizontal operational position charaterised in that;
(iv) said actuating means is controlled by a hand held controller or transmitter.

2. Boom gate apparatus as claimed in claim 1 wherein the portable trolley has a single pair of wheels and a handle.

3. Boom gate apparatus as claimed in claim 1 wherein the elongate gate comprises a single elongate arm.

4. Boom gate apparatus as claimed in claim 1 wherein the actuating means is a drive motor coupled by a belt or chain drive to a pivot arm which is operatively connected to the elongate gate by connection means.

5. Boom gate apparatus as claimed in claim 1 wherein the connection means is a connection sleeve or joint between the elongate gate and the pivot arm which is releasably attached to the elongate gate.

6. Boom gate apparatus as claimed in claim 5 wherein the elongate gate is connected to the connection sleeve by a splined or keyway arrangement so that the elongate gate and connection sleeve may rotate in unison.

7. Boom gate apparatus as claimed in claim 4 wherein the elongate gate is oriented normal to the pivot arm.

8. Boom gate apparatus as claimed in claim 4, wherein the drive motor is an electric motor powered by one or more batteries.

9. Boom gate apparatus as claim in claim 1 wherein the mobile trolley has a housing for the actuating means wherein in said housing there is located a receiver which receives a signal from the hand held controller or transmitter.

10. Boom gate apparatus as claimed in claim 9 wherein the signal is IR or RF.

11. Boom gate apparatus as claimed in claim 10 wherein the hand held controller is IR and the receiver is IR.

12. Boom gate apparatus as claimed in claim 11 wherein the housing has a transparent window located in an external wall thereof for transmission of the IR signal.

13. Boom gate apparatus as claimed in claim 11 wherein the housing includes an IR receiver which transmits a signal to an RF receiver in the housing which sends a signal to a microprocessor which actuates the drive motor.

14. Boom gate apparatus as claimed in claim 1 wherein there is provided a traffic indicator adjacent the elongate gate for indicating:
(i) when traffic is free to pass through the elongate gate when in an elevated non-operational position; and
(ii) when traffic is blocked from passing through the elongate gate when lowered to an operational position.

15. Boom gate apparatus as claimed in claim 14 wherein said traffic indicator includes a green light for position (i) and a red light for position (ii).

16. A pair of boom gate apparatus having components (i), (ii) and (iii) as defined in claim 1 remotely controlled and operated by a hand held transmitter or controller.

17. A method of operation of a pair of boom gate apparatus as claimed in claim 16 wherein said pair of apparatus is block adjacent lanes of a roadway to thereby prevent passage of traffic in different directions.

18. A method of operation of boom gate apparatus as claimed in claim 1 which includes the steps of:
(a) lowering the elongate gate by remote control using the hand held transmitter or controller to prevent passage of traffic along a roadway or lane of a roadway which said boom gate apparatus is located adjacent thereto;
(b) permitting one or more persons to cross the lane or roadway while the elongate gate is in the lowered position; and
(c) elevating the elongate gate to permit traffic along the roadway or lane when said one or more persons have crossed the roadway or lane.

19. A method as claimed in claim 18 wherein in step (a) and/or (b) a red light is flashing or other visual or audible indicator to indicate traffic should stop.

20. A method as claimed in claim 18 wherein in step (c) a green light is flashing or other visual or audible indicator to indicator traffic is free to pass along the roadway or lane previously blocked by the elongate gate.

21. A method claimed in claim 18 wherein a pair of said boom gate apparatus is used to block adjacent lanes of a roadway for traffic and steps (a), (b) and (c) are carried out simultaneously by each boom gate apparatus.
